(19) United States
(12) Patent Application Publication
(10) Pub. No.: US 2022/0315729 A1
(43) Pub. Date: Oct. 6, 2022

(54) NEW ABLATIVE COMPOSITE MATERIAL

(71) Applicant: NAVAL GROUP, Paris (FR)

(72) Inventors: Julien BEAUDET, Bouguenais (FR); Emeline ARNAUD, Reze (FR)

(21) Appl. No.: 17/597,298

(22) PCT Filed: Jul. 2, 2020
(86) PCT No.: PCT/EP2020/068686

§ 371 Date: Dec. 30, 2021

(30) Foreign Application Priority Data
Jul. 3, 2019 (FR) FR1907377

(51) Int. Cl. C08K 3/04; C08J 5/04

(52) U.S. Cl. CPC C08K 3/04; C08J 5/042; C08K 2201/003; C08K 2201/004; C08J 2363/00

(57) ABSTRACT

An ablative composite material including a matrix and a reinforcement, characterised in that: the matrix is a phenolic resin or an epoxy resin and the reinforcement is formed of short carbon fibres with a length of between 0.5 mm and 20 mm, and a diameter of between 6 μm and 20 μm.

The present invention relates to a new ablative composite material and to a method for its preparation. It also relates to a piece of said ablative composite material, the method of preparation of said piece, as well as the use of said material for the thermal protection of the surface of a fuel-propelled munition launcher.

When weapons are used on surface ships, the departure of munitions generates a very severe aerothermal aggression which requires that the firing point areas be protected by specific materials. Whether on the deck of ships or on more complex systems, the performance of thermal protection materials is essential to ensure the safety of the crew and the ship and to enable maximum availability of the combat system.

The performance of an ablative material is based on its ability to absorb the thermal and aerodynamic flow during the launch of a munition, owing to its suitable thermal and mechanical characteristics. When developing thermal protection, it is essential to identify the material properties that will promote energy dissipation during the ablation process. The more energy a material dissipates as it degrades, the better it will perform. In addition, the material must be a good insulator.

Ablation is a complex and highly coupled phenomenon involving chemical, thermal and mechanical mechanisms. The heat of ablation can be defined as the energy absorbed per mass of material consumed during ablation. The higher it is, the more energy is needed to degrade the material, or in other words, the less material is needed to protect a surface. It is logical to seek to maximise it. The ablation heat is directly related to the specific heat, enthalpies of reaction and emissivity of the material.

These solutions can be separated into two very different major families of materials: organic matrix composites and ceramic composites. Ultra-high-temperature ceramic materials are mainly made of borides, nitrides, carbides and oxides of metals such as hafnium, zirconium, tantalum or titanium. These elements have particularly high melting points, above 2,500° C. These are advanced technologies whose high cost is difficult to implement on large surfaces.

To date, there are several types of materials used as thermal protection or tested for ablative resistance, as well as some materials developed by industry. Examples include materials based on thermosetting resins, such as phenolic resin, materials based on elastomers, and ceramic or carbon-carbon materials.

Apart from the case of ceramic composites, it is possible to define the composite material with three main parameters: the resin, the reinforcement, and the architecture of the reinforcement. Despite the many combinations offered by these components, not all fibre-matrix combinations are equally effective. The issue of material cohesion is as important as the individual quality of each component of the composite.

The very severe stresses generated during firing cause severe the surface of the heat shields used to erode. It is therefore essential to offer material solutions whose behaviour is controlled to guarantee the availability of the equipment.

There is therefore a need for an ablative material to obtain satisfactory thermal insulation properties suitable for munition launchers in particular.

The present invention therefore aims to solve the problems of thermal insulation and degradation control during retained firing or a missile launch.

It is also intended to provide an ablative material with suitable thermal protection properties, in particular for use in the preparation of munition launchers.

Thus, the present invention relates to an ablative composite material comprising a matrix and a reinforcement, characterised in that:

the matrix is a phenolic resin or an epoxy resin and

the reinforcement is formed of short carbon fibres with a length of between 0.5 mm and 20 mm, and a diameter of between 6 μm and 20 μm.

The material according to the invention is thus formed of a matrix and short carbon fibres as reinforcement.

Preferably, the length of the carbon fibres is less than 20 mm.

The carbon fibres used in the invention can be obtained from pitch or PAN (polyacrylonitrile) precursors.

It is important that the material according to the invention can be adapted to be subjected to severe aerothermal stress. It is therefore desirable, and even essential, to limit porosity, particularly large pores which significantly accelerate the erosion of the material, and to ensure that the material is as homogeneous and isotropic as possible. Preferably, the cohesion and density of the carbon (carbon fibres) is maximised and the sensitivity to tearing is limited.

In one embodiment, the matrix of the material of the invention is a phenolic resin. Phenolic resins are essentially resins derived from formaldehyde and phenol.

Preferably, the phenolic resin is selected from novolac resins (prepared by acid catalysis) or resol resins (prepared by base catalysis). Preferably, the matrix of the material according to the invention is a phenolic matrix of the resole type.

According to one embodiment, the matrix of the material of the invention is a phenolic resin (phenolic matrix) and said material comprises a maximum of 60% by weight of short carbon fibres as defined above relative to the total weight of said material, said short carbon fibres preferably having a porosity of less than 15%.

In one embodiment, the material comprises at least 10% by weight of short carbon fibres as defined above relative to the total weight of said material.

Preferably, the matrix of the material of the invention is a phenolic resin and said material comprises 25% to 40% by weight of short carbon fibres as defined above relative to the total weight of said material, said short carbon fibres having a porosity of less than 5%.

Increasing the short carbon fibre content increases the conductivity of the material without degrading its ablative properties, thus limiting the temperature rise on the front face and limiting the loss of mass without compromising the insulating performance of the material.

A particularly preferred material according to the invention comprises a phenolic matrix reinforced with 25% by weight of short carbon fibres as defined above having a low porosity, in particular less than 5%. Preferably, the pore size of the carbon fibres is less than 1 mm. The functional characteristics of the material are the result of a compromise between the thermal conductivity of the material and its resistance to jet erosion.

In one embodiment, the matrix of the material of the invention is an epoxy resin.

In one embodiment, the ablative composite material according to the invention comprises a matrix which is an epoxy resin, and comprises a maximum content of 60% by weight of short carbon fibres as defined above relative to the total weight of said material, said material having a porosity of less than 15%.

In one embodiment, the material comprises at least 10% by weight of short carbon fibres as defined above relative to the total weight of said material.

In one embodiment, the ablative composite material comprises, as a matrix, an epoxy resin selected from flame-retardant epoxy resins.

Preferred flame-retardant epoxy resins include, for example, carbon-rich epoxy resins, particularly with a carbon residue at 1,000° C. under nitrogen of between 20% and 80% by weight.

According to a preferred embodiment, when the matrix is an epoxy resin, the material of the invention further comprises carbon powder, preferably in a mass content of between 5% and 20% relative to the total mass of said material.

Examples of carbon powder include carbon powder with a particle size of less than 1 mm.

The present invention also relates to a method of preparing the ablative composite material as defined above, comprising mixing the matrix and reinforcement as defined above.

The present invention also relates to a method of preparing a piece of ablative composite material as defined above. This method essentially consists of compression moulding (mould/mandrel). The method of preparation and associated parameters make it possible to control the final quality and characteristics of the resulting material.

In one embodiment, the method of the invention comprises a step of mixing the matrix and the reinforcement, and a step of compression-moulding said mixture.

Thus, the present invention also relates to a method of preparing a piece of ablative composite material as defined above, comprising a phenolic resin as a matrix.

The present invention therefore also relates to a method of preparing a piece of ablative composite material as defined above, wherein the matrix is a phenolic resin, and comprising from 10% to 60% by weight of short carbon fibres relative to the total weight of said material.

Said method consists of several steps allowing the implementation of the invention. The manufacturing cycle involves pressurising and tempering the mixture in a number of different cycles (temperature/pressure combination) to achieve the required material characteristics.

The implementation cycle is adapted to the nature of the phenolic resin used. The key parameter for implementation is therefore the combination of pressure and temperature. Compression-based processing is essential in order to obtain a material that meets the desired performance. Homogeneous mixing and perfect distribution of the fibres in the mix guarantee first-class performance.

The present invention also relates to a method of preparing a piece of ablative composite material as defined above, comprising a phenolic resin as a matrix.

The present invention therefore also relates to a method of preparing a piece of ablative composite material as defined above, wherein the matrix is an epoxy resin, comprising from 10% to 60% by weight of short carbon fibres relative to the total weight of said material. Said method consists of several steps allowing the implementation of the invention. The manufacturing cycle involves pressurising and tempering the mixture in a number of different cycles (temperature/pressure combination) to achieve the required material characteristics.

The implementation cycle is adapted to the nature of the epoxy resin used. The key parameter for implementation is therefore the combination of pressure and temperature. Compression-based processing is essential in order to obtain a material that meets the desired performance. Homogeneous mixing and perfect distribution of the fibres in the mix guarantee first-class performance.

The present invention also relates to a piece of ablative composite material, said material being as defined above. Preferably, the present invention relates to a piece of ablative composite material obtained by the aforementioned method.

The present invention also relates to a method of thermally protecting the surface of a fuel-propelled munition launcher, comprising applying a piece as defined above to said surface.

Preferably, the thermal protection method of the invention is intended to protect the firing environment from the departure of munitions, particularly munitions propelled by solid fuel.

Examples of equipment for launching fuel-propelled munitions include vertical, tiltable or inclined missile launchers.

The present invention therefore also relates to fuel-propelled munition launchers, comprising at least one piece of ablative composite material as defined above.

### EXAMPLES

### Example 1: Preparing a Piece of Ablative Material Comprising a Phenolic Resin

A piece of material comprising a phenolic resin according to the invention is prepared according to the method described in Table 1 below.

TABLE 1

| Step 1 | Preparation |
|---|---|
| | Preparation of the mixture: mixing the components and inserting |
| | them into the hot mould. |
| Step 2 | Moulding |
| | Pressurisation of the mixture with a multi-stage pressurisation |
| | and temperature-raising cycle. The holding times allow for |
| | optimal firing of the plate with the required characteristics. |
| Step 3 | Demoulding |
| | The piece exits. |

### Example 2: Preparing a Piece of Ablative Material Comprising an Epoxy Resin

A piece of material comprising an epoxy resin according to the invention is prepared according to the method described in Table 2 below.

TABLE 2

| Step 1 | Preparation |
|---|---|
| | Preparation of the mixture: Mixing the components and inserting |
| | them into the hot mould. |
| Step 2 | Moulding |
| | Pressurisation of the mixture with a multi-stage pressurisation |
| | and temperature-raising cycle. The holding times allow for |
| | optimal firing of the plate with the required characteristics. |
| Step 3 | Demoulding |
| | The piece exits. |

### Example 3: Ablative Properties of Materials

Inventions based on phenolic and epoxy resins have a homogeneous distribution of carbon fibres without any preferential orientation.

The main thermo-physical characteristics are shown in the table below.

TABLE 3

| | Phenolic | | Epoxy | |
|---|---|---|---|---|
| Characteristic | material | | material | |
| Thermal | <1 | W · m⁻¹ · K⁻¹ | >1 | W · m⁻¹ · K⁻¹ |
| conductivity | | | | |
| Density | >1,000 | Kg · m⁻³ | >1,000 | Kg · m⁻³ |
| Porosity | <15% | | <15% | |
| Specific heat | >1,000 | J · kg⁻¹ · K⁻¹ | >1,000 | J · kg⁻¹ · K⁻¹ |
| Ablation rate on | 0.5 | mm/s | 1 | mm/s |
| liquid hydrogen/ | | | | |
| oxygen bench | | | | |
| (M = 3 and | | | | |
| T = 1900° C.) | | | | |

During degradation, the material must degrade in a safe, linear manner. This means that the erosion must be gradual, and controlled with good linearity of cratering as the exposure time increases. During degradation, the charcoal from the degradation must remain confined to the upper part of the plate, and the thermal setting must not lead to deep degradation of the thermal protection.

1. An ablative composite material comprising a matrix and a reinforcement, wherein:
the matrix is a phenolic resin or an epoxy resin, and
the reinforcement is formed of short carbon fibres with a length of between 0.5 mm and 20 mm, and a diameter of between 6 μm and 20 μm, having a porosity of less than 15%.

2. The ablative composite material of claim 1, wherein the matrix is a phenolic resin, and comprises at most 60% by weight of short carbon fibres relative to the total weight of said material.

3. The ablative composite material of claim 2, wherein the phenolic resin is selected from novolac resins or resol resins.

4. The ablative composite material of claim 1, wherein the matrix is an epoxy resin, and comprises at most 60% by weight of short carbon fibres relative to the total weight of said material, said short carbon fibres having a porosity of less than 15%.

5. The ablative composite material of claim 4, wherein the epoxy resin is selected from flame-retardant epoxy resins.

6. The ablative composite material of claim 4, further comprising carbon powder, preferably in a mass content of between 5% and 20% relative to the total mass of said material.

7. A method of preparing the ablative composite material according to claim 1, comprising mixing the matrix and the reinforcement.

8. A piece of ablative composite material according to claim 1.

9. (canceled)

10. The piece of ablative composite material of claim 8, which is a part of a fuel-propelled munition launcher.
